(19) United States
(12) Patent Application Publication
(10) Pub. No.: US 2008/0105099 A1
(43) Pub. Date: May 8, 2008

(54) Portable Cutting Jig and Support Member

(76) Inventor: Michael John Backman, Portland, ME (US)

Correspondence Address: CHRIS A. CASEIRO, VERRILL DANA, LLP, ONE PORTLAND SQUARE, PORTLAND, ME, 04112-0586, US

(21) Appl. No.: 11/555,724

(22) Filed: Nov. 2, 2006

(51) Int. Cl. B26D 7/02

(52) U.S. Cl. 83/468.4; 269/71; 269/95; 83/745

(57) ABSTRACT

A portable jig for cutting a plurality of building materials quickly, uniformly and accurately, which may be quickly assembled and reassembled for easy transport and maintenance. The jig includes a platform, a deck, a deck fence, an optional platform fence, and two rails. The rails are removably and securably connectable to the fixed platform and passable through the deck, such that both rails are separated from each other. The deck fence is reversibly joinable to the deck. When the platform fence is included, the platform fence is reversibly joinable to the platform. While building materials are laid upon the jig for cutting, a cutting device, such as a circular saw blade, may be passed near and along either of the deck or platform fences to effect this cutting of one or both ends of the building materials. The jig further includes an optional support member for supporting the jig when it is being used.

### BACKGROUND OF THE INVENTION

1. Field of the Invention

The present invention relates to cutting devices. More particularly, the present invention relates to cutting devices that may be used to uniformly and precisely cut a plurality of pieces of a variety of materials. Still more particularly, the present invention relates to cutting devices that may be quickly assembled and disassembled for easy transport from one location to another.

2. Description of the Prior Art

Carpentry is one of mankind's oldest, most practiced, and most important professions. Indeed, millions of carpenters around the globe work each day to build the structures in which we live, work, and play, such as single-family homes, apartment buildings, sports arenas, shopping malls, small office buildings, and skyscrapers, and to make repairs and improvements to those structures. Although carpentry has long been, and is often, practiced, the profession remains prone to inefficiency which can substantially delay the completion of a project. Perhaps the most rate-limiting steps of any carpentry project are those taken during the preparation of the materials that are to be used to build, repair, or improve the structure. For example, for nearly every project, a plurality of raw materials, such as lumber, piping, sheetrock, and stone, not only must be cut, but must be cut to an exact size before these materials can then be added to the structure. For both the work-alone carpenter and the carpenter who is part of a team, the rate at which these materials are prepared therefore can substantially affect the rate at which the carpenter or team performs.

Other rate-limiting steps occur during the preparation of the work site itself. The task of preparing a work site often involves unloading heavy equipment from a construction vehicle onto the work site, and can further involve moving this equipment to and from a variety of positions at the site during the course of the project. Additionally, at the end of each work day, this equipment usually must be moved to a safe and sheltered location, which may entail loading the equipment back onto a construction vehicle and driving it to a location removed from the work site, and perhaps even removing it from the vehicle after it arrives at the remote site. All of this moving is burdensome because it consumes time that otherwise could be spent performing actual carpentry work.

Further, the selection of locations within a work site where particular devices will be used can be time-consuming and problematic. This is true partially because some equipment can only be used in certain locations. For example, some equipment only can be used on a sturdy, flat surface, such as a bench top or picnic table top. When such a surface is needed, time spent locating and/or waiting to use that surface is wasteful. Worse, sometimes a surface is not even available. When a suitable surface is not available, the carpenter usually must instead settle for an undesirable surface, such as the bare ground, upon which to operate his device. This can be frustrating, or even worse, it can be dangerous.

Yet another rate-limiting aspect of carpentry is the time spent maintaining tools and equipment. This maintenance includes both the routine maintenance of normally working devices, such as cleaning sawdust from crevices between their moving parts, and the maintenance required to restore defective devices to their normal working condition, such as when parts of these devices become inoperable and must be replaced. For any carpenter, time spent maintaining carpentry devices is lost time. All carpenters therefore desire to have tools and equipment that are easy to maintain.

For all of the above reasons, the best carpentry device for cutting a plurality of building materials is one that requires minimal time to prepare these materials, is self-supporting, and is easily maintained and transported. None of the existing devices for cutting a plurality of building materials, however, appear to be optimally efficient, self-supporting, and easy to maintain and transport.

For example, U.S. Pat. No. 4,995,288 issued to DellaPolla describes a saw guide which may be used to cut wood. One significant drawback to the DellaPolla device, however, is that is it not designed to be easily transported. This is true mainly because it contains numerous parts, many of which must be fitted together using nuts, bolt, washers, and similar fastening members. Therefore, while the DellaPolla device may be disassembled and reassembled, disassembling and reassembling the device would not be desirable because doing so would consume precious time.

The DellaPolla device is further limited by another aspect of its design, which is namely that the saw used with the device must be affixed to the device during normal operation. This required connection of the saw to, and any disconnection of the saw from, the device, such as would be needed for cleaning or transport, are needlessly time-consuming. Finally, the DellaPolla device does not include its own support member.

As a second example, U.S. Patent No. 2,613,707 issued to Giles also describes a lumber cutting jig having a saw guide. The Giles jig is described as being “light weight and freely portable.” It is clear that the Giles jig is not, however, optimally lightweight or optimally portable. This is true because the Giles jig includes one or more large frames of a fixed conformation. While it is possible to disassemble and reassemble these frames, doing so would involve manipulating several fastening members, which would be a very time-consuming, and therefore undesirable, undertaking. Further, whereas the frames could be carried in their assembled state, this would not be desirable because the assembled frames are bulky and therefore are not easy to transport. For example, they would not be easy to transport whenever the carpenter using them has to fit much equipment in a small space, such as in the back of a small truck or a small storage closet at a work site.

Another significant limitation of the Giles jig is that it is not easy to use when the materials that it is being used to cut are more than a few feet in length. This is true because to ready the Giles device to cut larger materials, its user first must perform the laborious step of fastening together multiple frames. Therefore, the Giles device is not optimally designed for cutting larger materials. Finally, yet another limitation of the Giles device is that it does not include its own support member.

As a third example, U.S. Pat. No. 6,742,432 issued to Langis describes a frame for cutting balusters. One significant limitation of the Langis device is that it is cumbersome to use. In particular, once balusters are loaded onto the Langis device, the user must make multiple adjustments to the device just to prepare it to cut the balusters to a desired length. First, the user must move a telescoping two-part frame of the device to approximate the length of the cut. Thereafter, the user must wind two microadjustment bolts to more precisely adjust the device for cutting. All of these adjustments require much time to perform. A cutting device requiring fewer adjustments at this step would save time.

Even more limiting, the Langis device is designed to associate with only one saw blade-guiding fence, and still more limiting, is designed to only associate with that fence at a particular position on the device. This single/nonpositionable fence design is disadvantageous because it forces a user of the device needing to cut materials at both ends to load the materials onto the jig, position the fence to make the first cut, make the first cut, turn the materials 180 degrees upon the surface of the jig, and make the second cut. In contrast, a device having two positionable saw fences would obviate the step of turning the materials on the jig, which can be a time-consuming process, especially when several pieces of material are being cut. Therefore, because the Langis device is cumbersome to adjust for cutting and requires users needing to make two cuts to take the time to turn the materials in between cuts, the Langis device is not optimally designed.

Further, the Langis device is not optimally designed to resist the rigors associated with heavy use. For example, the junction between the two parts of its telescoping frame is susceptible to clogging by saw dust and wood chips, such as would likely occur after only one or a few uses of the device. Because failure to clean such debris from the device likely would cause the device to malfunction, the Langis device must be cleaned regularly. Finally, yet another limitation of the Langis device is that it does not include its own support member.

What is needed therefore is a jig for cutting a plurality of building materials quickly, uniformly and accurately. Further, what is needed is a jig for cutting a plurality of building materials which is highly durable, and therefore is able to withstand the rigors associated with cutting large quantities of such materials, such as exposure to sawdust or metal dust, and other rigors of carpentry work, such as frequent transportation of the jig. Further still, what is needed is a jig for cutting a plurality of building materials which may be assembled and disassembled quickly and with minimal effort for easy transport of the jig. Even further, what is needed is a jig for cutting a plurality of building materials which obviates the need to locate another, and possibly inferior, support member to rest the jig upon during use.

### SUMMARY OF THE INVENTION

It is an object of the present invention to provide a portable cutting jig for cutting a plurality of building materials quickly, uniformly and accurately. The present invention is a cutting jig designed to achieve this object primarily by limiting both the number and the scope of the manipulations that the user of the jig must perform to prepare and use the jig to cut. Specifically, the jig is capable of cutting large loads of building materials, such as, for example, a block of 32 boards of 2″×4″ lumber (16 boards stacked two deep), with a single pass of a saw blade. In addition to saving the user valuable time, this increased load capacity allows the user to reduce the possibility that he/she will be injured by the blade. This is true because the ability to cut large loads with a single pass effectively limits the user's exposure to the saw blade.

The jig of the present invention includes a deck fence used to guide a saw blade. The jig also includes an optional platform fence. The platform fence allows the user to cut materials at both ends without manipulation between cuts. Of further advantage, the deck fence and optional platform fence may be positioned and repositioned quickly and easily to expedite cutting.

It is another object of the present invention to provide a cutting jig which is easy to maintain. The moving parts of the jig are designed to resist build up of saw dust, metal dust, and other debris that otherwise would cause the jig to malfunction over time. Also, many components of the jig are easily removed, and therefore, are easy to replace when they become defective.

It is another object of the present invention to provide a cutting jig which may be easily transported, such as from one work site to another work site or between two areas of the same work site. The jig may be disassembled or assembled simply by performing a few easy joining or unjoining steps involving just a few components of the jig. When disassembled, the components of the jig may be stored in a carrying device, such as a canvas or nylon bag, for easy and lightweight carrying.

It is another object of the present invention to provide a cutting jig which furnishes its own support, and therefore which eliminates the need for the jig user to perform the sometimes time-consuming and even impracticable task of having to locate some other suitable support surface. Toward this objective, the jig optionally includes a portable support member that, like the jig itself, is easy to use, assemble and disassemble, maintain, and transport.

### BRIEF DESCRIPTION OF THE DRAWINGS

FIG. 1 is a perspective view of a partially assembled cutting jig of the present invention in a first embodiment.

FIG. 2A is a perspective view of a first arrangement of a fixed platform of the cutting jig of the present invention.

FIG. 2B is a perspective view of a second arrangement of the fixed platform of the cutting jig of the present invention.

FIG. 3 is a perspective view of an adjustable deck of the cutting jig of the present invention.

FIG. 4 is a perspective view of a first embodiment of a deck fence of the cutting jig of the present invention in the first embodiment.

FIG. 5 is a top view of a fully assembled cutting jig of the present invention with building materials placed thereon.

FIG. 6 is a close-up first side view of a portion of a second embodiment of the cutting jig of the present invention showing a fence connecting member in a first position.

FIG. 7 is a close-up second side view of a portion of the second embodiment of the cutting jig of the present invention showing the fence connecting member in a second position.

FIG. 8 is a perspective view of the cutting jig of the present invention showing the jig with a deck fence and an optional platform fence.

FIG. 9A is a side view of a portable jig support member of the cutting jig of the present invention shown as supporting the cutting jig in a position that is substantially parallel to a ground surface.

FIG. 9B is a side view of a portable jig support member of the cutting jig of the present invention shown as supporting the cutting jig in a position that is not substantially parallel to the ground surface.

### DETAILED DESCRIPTION OF THE PREFERRED EMBODIMENT

The present invention is a portable cutting jig for cutting a plurality of building materials quickly, uniformly and accurately. The jig includes components which may be quickly assembled and disassembled to either construct the jig into its operable form or to break it down for easy storage, transport, and maintenance.

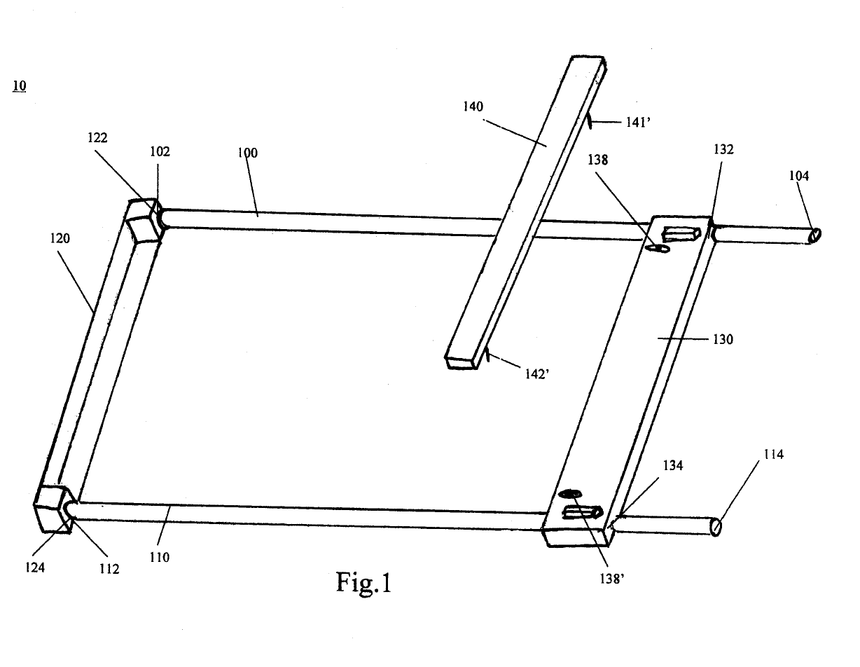

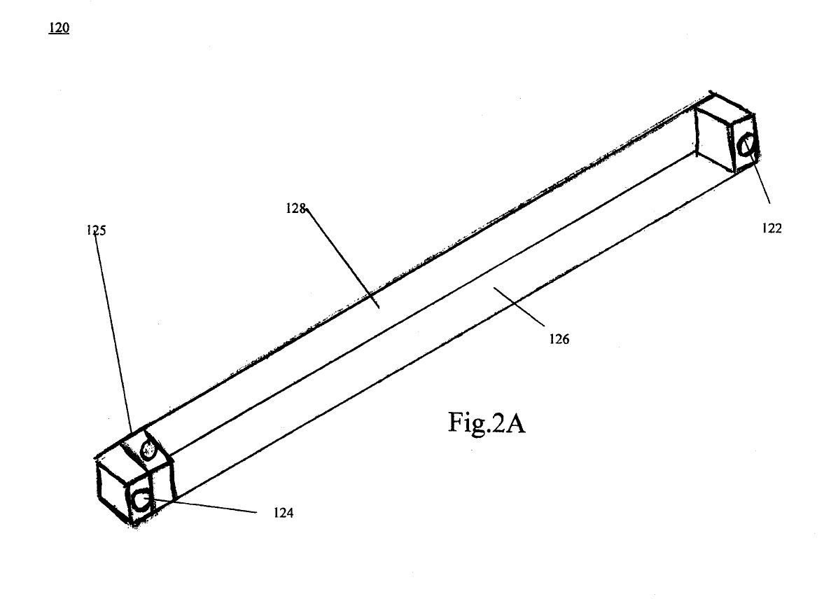

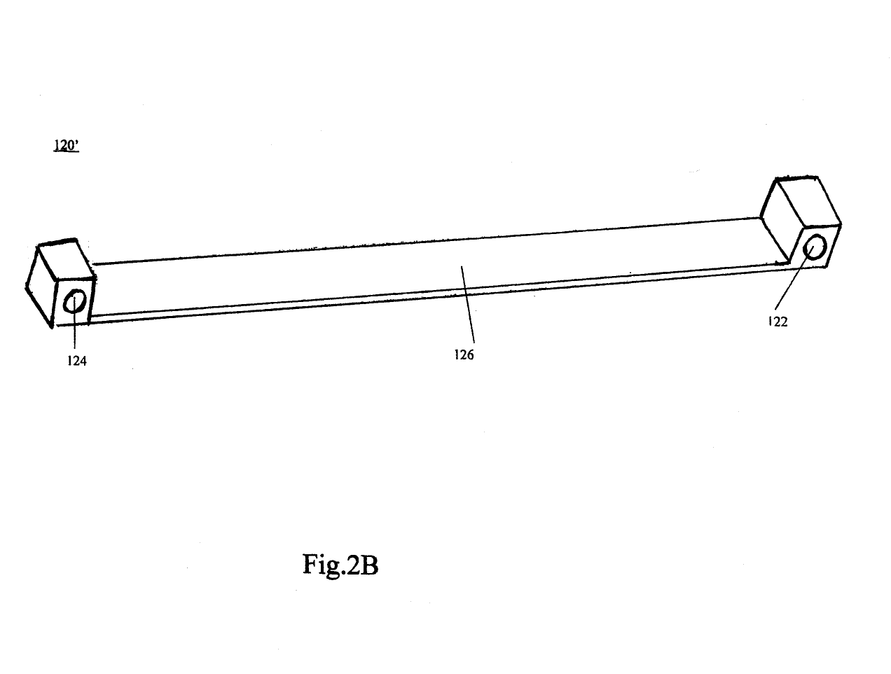

In a first embodiment of the present invention shown in FIGS. 1-2B, the jig 10 includes a first rail 100, a second rail 110, a platform 120, an adjustable deck 130, and a removable deck fence 140. The first rail 100 includes first end 102 and second end 104. The second rail 110 includes first end 112 and second end 114. It is to be understood, however, that while the jig 10 is shown as having two rails 100/110, the jig 10 may have one or more additional rails.

The platform 120 includes first port 122 and a second port 124. First end 102 of the first rail 100 and first end 112 of the second rail 110 are removably and securely insertable into first port 122 and second port 124. To partially assemble the jig 10 into its operable form, first end 102 of the first rail 100 is inserted into port 122, and first end 112 of the second rail 110 is inserted into port 124 (as shown in FIG. 1). Specifically, the insertion and secure holding of the ends 102/112 in the ports 122/124 may be achieved in any number of ways. For example, in the preferred embodiment, the ends 102/112 are male threaded and the ports 122/124 are female threaded, and either one of the ends 102/112 may be inserted into either one of the ports 122/124, with the male threading of the inserted end 102/112 being turned until the end 102/112 securely engages with the female threading of the port 122/124. Alternatively, the ends 102/112 and the ports 122/124 are not threaded, and either end 102/112 is inserted into either port 122/124 until the end 102/112 is sufficiently held in the port 122/124 by friction between the end 102/112 and the port 122/124. It is to be understood however that the above descriptions of how the ends 102/112 may be secured in the ports 122/124 are for purposes of example only. Therefore, the ends 102/112 are not limited to being securely held in the ports 122/124 as described above.

Referring to FIG. 2A, in a first arrangement, the platform 120 further includes a recessed base surface 126. Base surface 126 abuts side wall 128, such that base surface 126 and side wall 128 form an essentially right angle. In a second arrangement shown in FIG. 2B, platform 120′ includes base surface 126, but does not include side wall 128. In both arrangements, the platform 120/120′ optionally may include one or more adjustable members 125 which may be reversibly fixable to the platform 120/120′. For example, the optional adjustable member 125 may be slidable along surface 126 of the platform 120/120′ and reversibly fixed at a particular location along the surface 126.

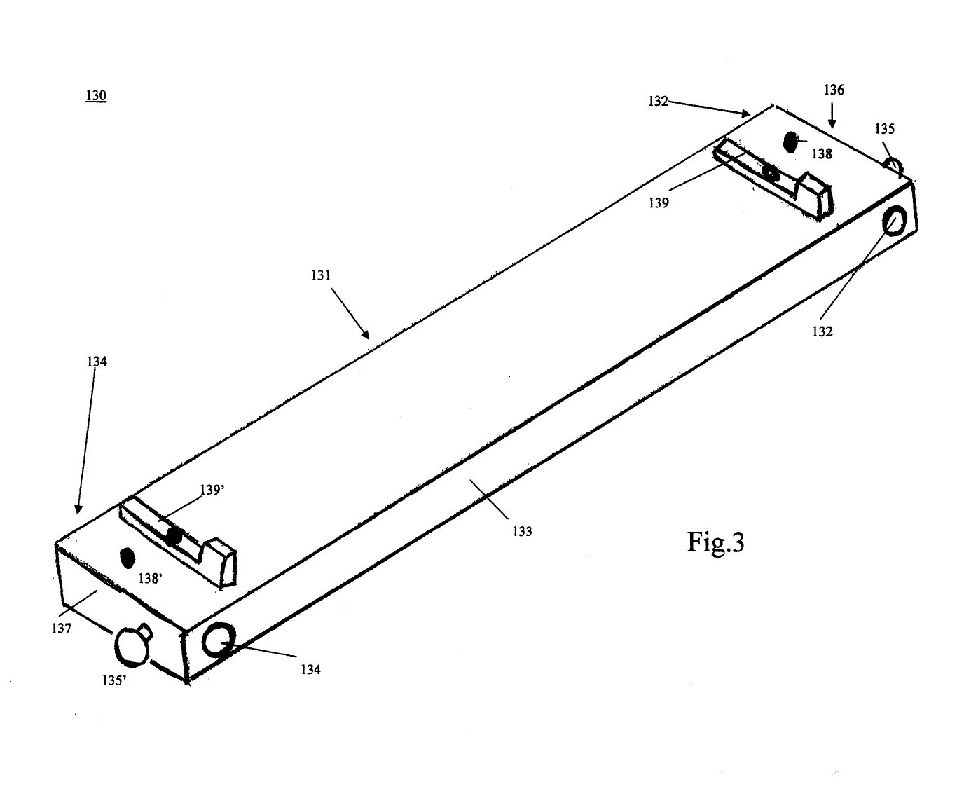

As shown in FIG. 3, the deck 130 includes a first channel 132 and a second channel 134 spaced from the first channel 132. Both channels 132/134 extend entirely through the deck 130 such that they are accessible from both first side surface 131 and second side surface 133 of the deck 130. As shown in FIG. 1, the deck 130 may be loaded onto rails 100/110 by passing second end 104 of the first rail 100 entirely through first channel 132, and second end 114 of the second rail 110 entirely through second channel 134. In this arrangement, the deck 130 may be slid along the rails 100/110 toward or away from the platform 120.

The deck 130 further includes one or more securing devices 135 for reversibly securing the deck 130 to the rails 100/110. As shown in FIG. 3, the deck 130 includes a first securing device 135 and a second securing device 135′, each of which are threaded rotatable pins. The pin of the first securing device 135 extends into end face 136 of the deck 130 such that it is extendable into channel 132, and the pin of the second securing device 135′ extends into end face 137 such that it is extendable into channel 134. The securing devices 135/135′ may be rotated in one direction, such as a clockwise direction, to move their pins into their channel 132/134, and may be rotated in the opposite direction, such as a counterclockwise direction, to move their pins out of their channel 132/134. In this arrangement, the rails 100/110 may be extended through channels 132/134 and the deck 130 may be slid along the rails 100/110 whenever the pins of the securing devices 135/135′ are removed from their respective channel 132/134. When the rails 100/110 are in the channels 132/134, the deck 130 may be securely locked in a fixed position by rotating the pins of the securing devices 135/135′ into the channel 132/134 until sufficient pressure to prevent them from sliding upon the rails 100/110. In an alternative embodiment, the pins of the securing devices 135/135′ are not threaded, but are instead spring-loaded. In this arrangement, the spring-loaded pins are removed from the channels 132/134, the rails 100/110 are inserted into the channels 100/110, and the pins are released to contact, and thereby exert pressure on, the rails 100/110. This exerted pressure is sufficient enough to securely hold the rails 100/110 in the channels 132/134. While the securing devices 135/135′ have been described as being either a rotatable pin or a spring-loaded pin, it is to be understood that the securing devices 135/135′ are not limited to these designs. Therefore, the securing device 135 may be any device which may be used to secure the deck 130 to the rails 100/110.

The deck 130 further includes two joining member receiving ports, first joining member receiving port 138 and second joining member receiving port 138′, and two fence supports, a first deck fence support 139 and a second deck fence support 139′, for supporting the deck fence 140. While the supports 139/139′ are shown in FIG. 3 as being L-shaped, it is to be understood that the supports 139/139′ are not limited to being L-shaped. Further, either or both of the deck fence supports 139/139′ optionally may be adjustable along, and reversibly fixable to, the deck 130. For example, support 139′ may be slidable toward and away from support 139.

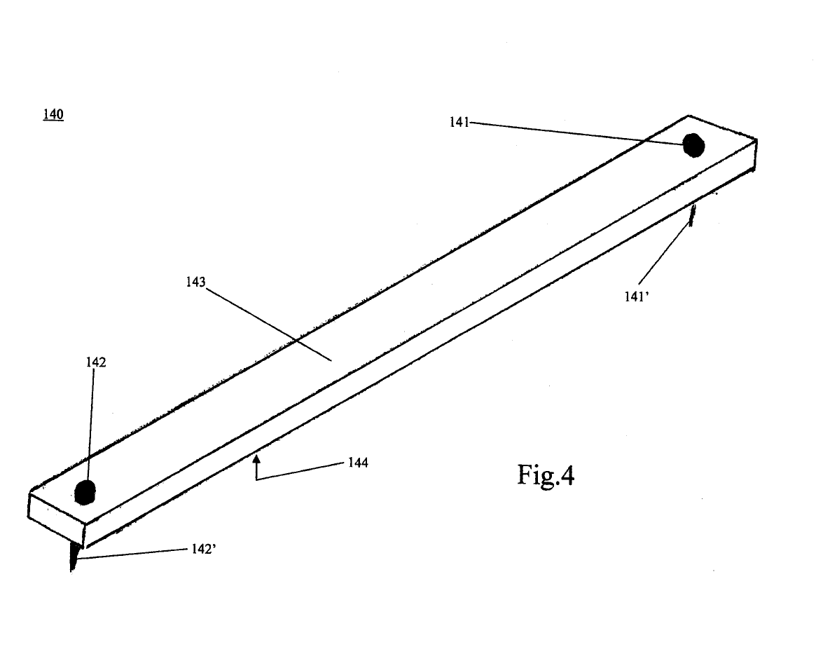

The deck fence 140 shown in FIG. 4 includes a first joining member 141 and a second joining member 142 spaced from the first joining member 141 for joining the deck fence 140 to the deck 130. The first joining member 141 and the second joining member 142 are removably connectable to the deck fence 140 and each is shown in FIG. 4 as a nail or nail-like. The first joining member 141 and second joining member 142 extend through top surface 143 and bottom surface 144 of the deck fence 140, such that end 141′ of member 141 and end 142′ of member 142 are substantially perpendicular to the bottom surface 144. It is to be understood, however, that while the first joining member 141 and second joining member 142 are shown in FIG. 4 as nails or nail-like, either one instead may be, but is not limited to being, a shaft, shank, stud, pin, peg, rod, bolt, dowel, bar, screw or any other device which may be used to reversibly join the deck fence 140 to the deck 130.

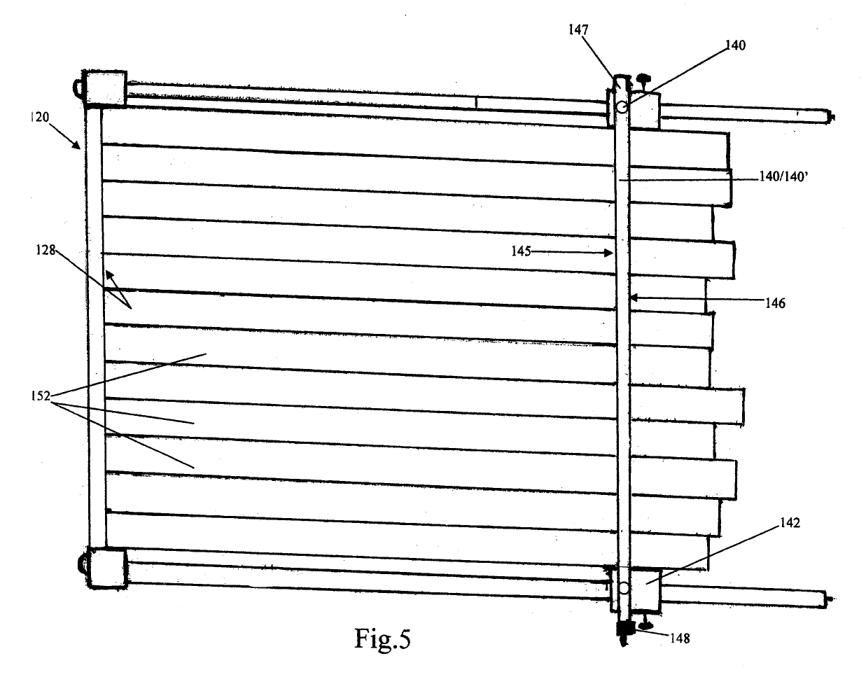

As shown in FIGS. 1 and 5, end 141′ of the first joining member 141 and the second end 142′ of the second joining member 142 may be reversibly inserted into first joining member receiving port 138 and second joining member receiving port 138′, respectively, of deck 130. In FIG. 1, the deck fence 140 is shown as being removed from the ports 138/138′, and in FIG. 5, the deck fence 140 is shown as being inserted into the ports 138/138′.

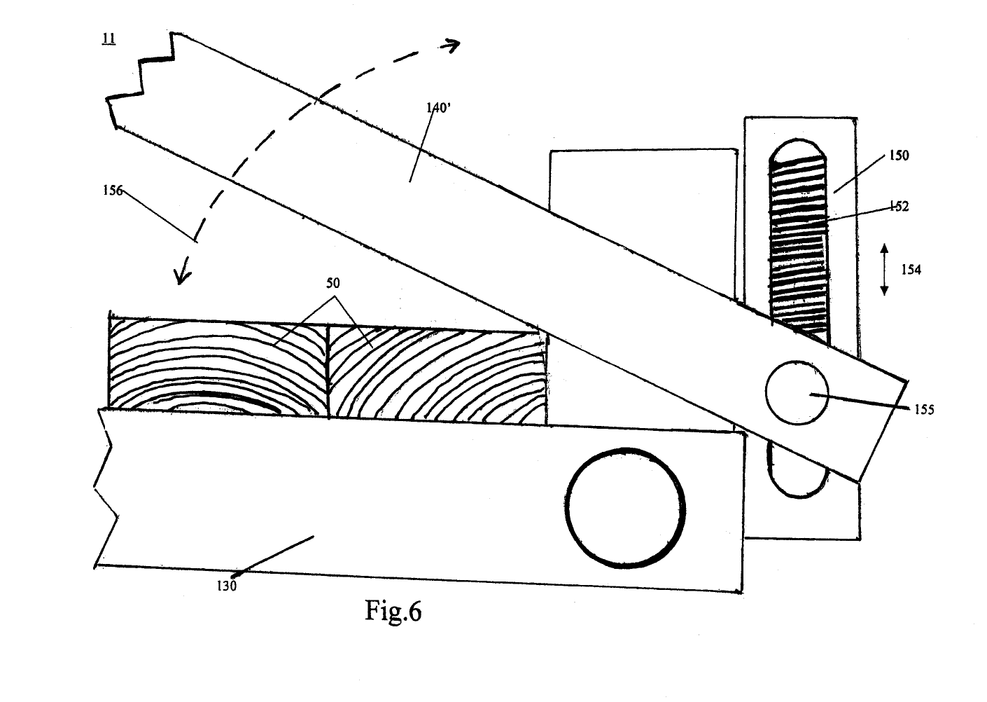

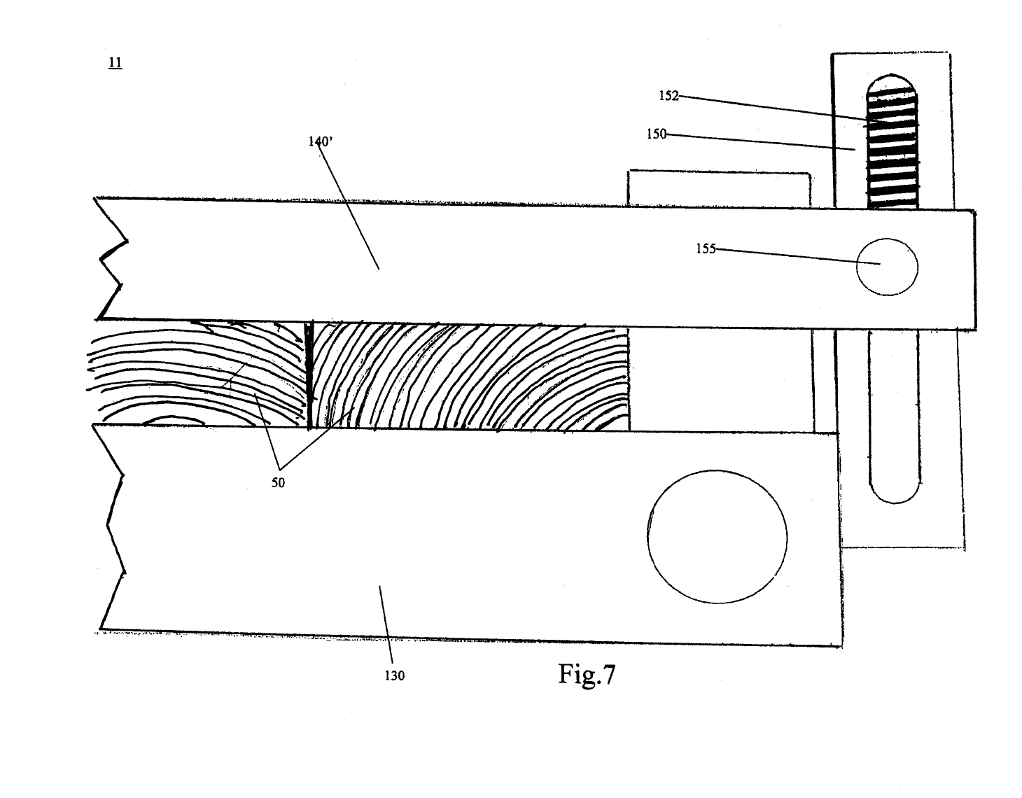

In a second embodiment of the present invention shown in FIGS. 6 and 7, jig 11 includes a deck fence 140′ which is adjustably or removably connected to the deck 130 by a fence connecting member 150. The connecting member 150 includes a spring-hinge 152, but it is to be understood that the connecting member 150 need not include a spring-hinge 152, as the connecting member 150 instead may be, or may include, any device suitable for fixing the fence 140′ to the deck 130. Further, the jig 11 is not limited to including only one connecting member 150, as it may include a plurality of connecting members 150. When the spring-hinge 152 is included, the deck fence 140′ may be pivoted on pin 155 of member 150 toward or away from the deck 130 in an arc represented by line 156. Further, the pin 155 is movable in a vertical linear plane 154. In this arrangement, the fence 140′ may be moved away from the deck 130 on pin 155 for placement or removal of building materials 50. Whenever materials 50 are loaded onto the deck 130 for cutting, the deck fence 140′ may be moved in a first step until it contacts the materials 50, such as shown in FIG. 6. In a second step, the deck fence 140′ may be moved until it is held flush with the materials 50, such as shown in FIG. 7. When the deck fence 140′ is flush with the materials 50, the deck fence 140′ may, but need not, be reversibly locked to hold it flush by using any device suitable for holding the deck fence 140′ flush. For example, the deck fence 140′ may include a hook and the deck 130 may include a loop that is capable of receiving the hook.

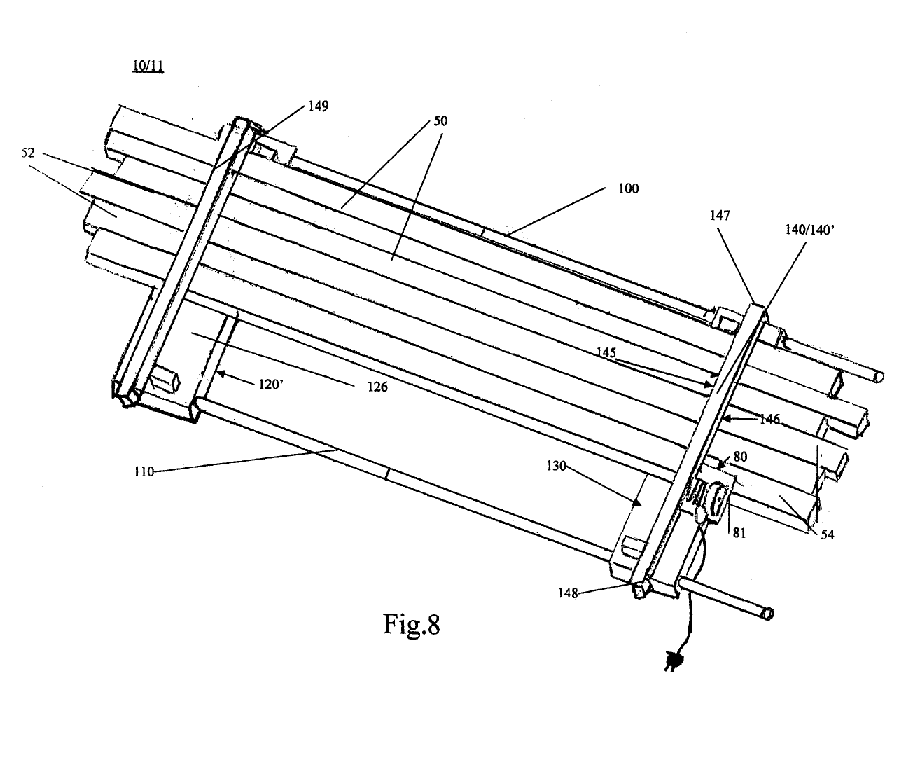

When the jig 10/11 includes platform 120′ of FIG. 2B, the jig 10/11 may further include optional platform fence 149 joinable to platform 120′ as shown in FIG. 8. The platform fence 149 includes the features of the deck fence 140/140′. The platform fence 149 includes the equivalents of the first and second joinable members 141/142 for reversibly joining the platform fence 149 to the platform 120′, such as is shown in FIG. 8. Alternatively, the platform fence 149 may be fixedly connected to the platform 120′ via another fence connecting member 150 (not shown).

When the first embodiment jig 10 is fully assembled, the jig 10 may be used to cut building materials 50 as follows. With reference to FIG. 5, which shows the jig 10 having only the deck fence 140/140′, in a first step, the materials 50 having ends 52 and 54 are loaded onto the platform 120 and deck 130 such that end 52 of each of the materials 50 rests upon the base surface 126 of the platform 120 and abut side wall 128. Each of the materials 50 further rests upon the deck 130, and may even extend past the deck 130 in a direction away from the platform 120. When either or both of the deck fence supports 139/139′ are adjustable and reversibly fixable to the deck 130, the adjustable support or supports 139/139′ may be adjusted until they are flush against the materials 50, and then reversibly fixed to the deck 130. This may be useful, for example, to hold the materials 50 tightly together in a reversibly fixed position upon deck 130. Similarly, when the platform 120 includes an adjustable holding member 125, the adjustable holding member 125 may be adjusted until the member 125 is flush against the materials 50, and then the member 125 may be reversibly fixed to the platform 120. In a second step, the deck 130 is moved toward or away from the platform 120 until first side 145 or second side 146 of the fence 140/140′ is positioned at the point along the materials at which the cut is to be made. In a third step, the deck 130 is locked into place by using the securing device or devices 135. In a fourth step, a cutting device blade of a cutting tool, such as the blade 81 of tool 80 in FIG. 8, is positioned near first end 147 of the fence 140/140′ such that the blade is substantially parallel to, and near, the first side 145 of the fence 140/140′. (Alternatively, the tool 80 may be positioned near second end 148 of the fence 140/140′ and/or the blade 81 may be substantially parallel to, and near, second side 146 of the fence 140/140′.) In a fifth and final step, the blade is moved along the length of the fence 140/140′ while cutting until it reaches first end 147. The cut materials 50 may then be easily unloaded from the jig 10/11 by merely lifting them away from the jig 10/11.

Alternatively, and with continuing reference to FIG. 8, the first step may involve loading the materials 50 onto the platform 120′ and deck 130 such that each of ends 52/54 of the materials 50 extends beyond the interval between the deck fence 140/140′ and the platform fence 149. In this arrangement, the second step involves moving the deck 130 toward or away from the platform 120′ until the distance between the deck fence 140/140′ and the platform fence 149 is substantially equal to the length of the materials 50 desired. The third step includes locking the deck 130 into place by using the securing device 135. In this alternative arrangement, the fourth and fifth steps include passing the blade 81 along the length of the deck fence 140/140′ and the platform fence 149. In this alternative arrangement, therefore, the materials 50 may be cut twice, specifically at ends 52 and 54, without having to manipulate the materials 50 between cuts.

It is to be understood that any one of a plurality of cutting devices may be used to cut materials 50 using the jig 10/11 of the present invention. For example, when wood is to be cut, the cutting device may be a circular saw. Exemplary circular saws for cutting wood include circular saws having a 10¼″ blade (such as The Big Foot® Saw, which is manufactured by Big Foot Tools of Henderson, Nev.) Other exemplary circular saws for cutting wood include those having a 16 5/16″, 8¼″, or 7¼″ blade (such as Makita Model Nos. 5402NA, 5008NB, and 5007NBK, respectively, all of which are commercially available from Makita U.S.A. Inc., La Mirada, Calif.). As another example, when metal is to be cut, any of the circular saws described above may be fitted with a blade that is specifically designed to cut metal. As yet another example, when masonry is to be cut, the cutting device may be a powered circular masonry saw. An exemplary masonry saw is one which includes a 5″ blade, such as Makita Model No. 4101RH, which is commercially available from Makita U.S.A. Inc., La Mirada, Calif.). No matter which cutting device is used with the jig 10/11, the blade 81 of the cutting device should be sufficiently large enough to cut entirely through the materials 50 while avoiding contact with the rails 100/110 or any other parts of the jig 10/11.

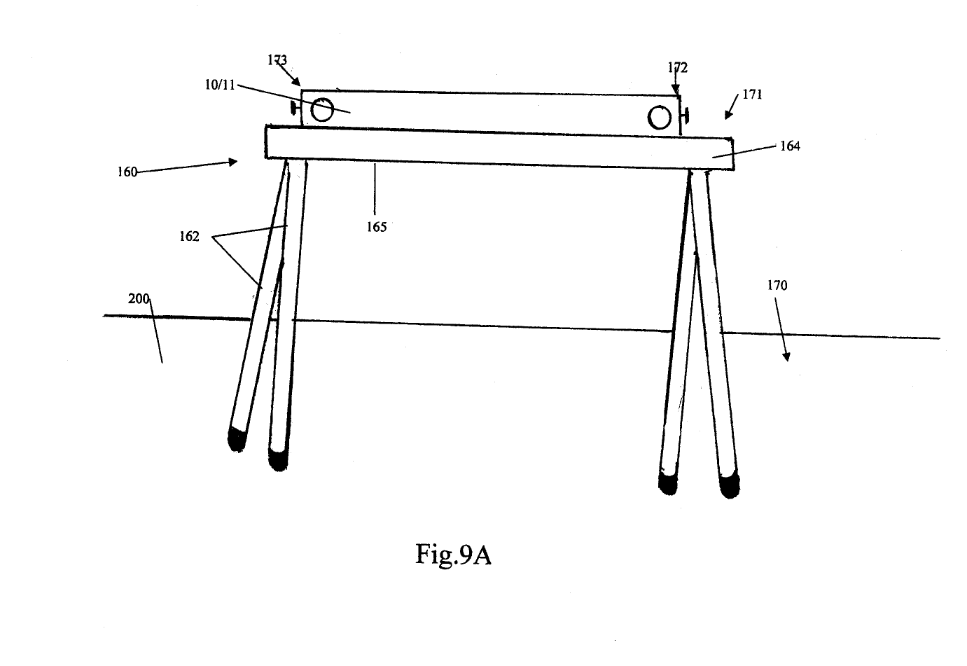

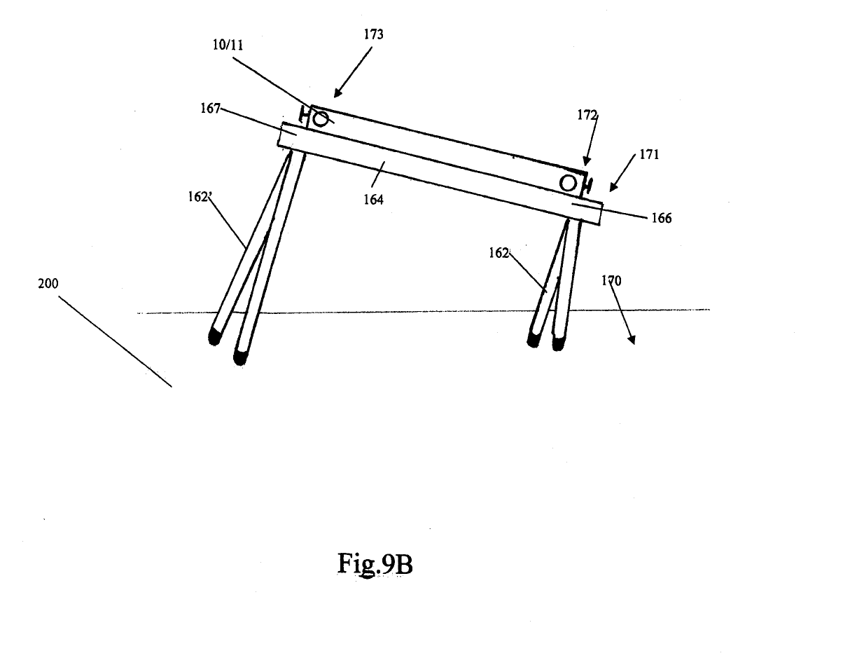

The present invention further includes an optional portable jig support member 160 shown in FIG. 9A for supporting the jig 10/11 while it is assembled for operation. The jig supporting member 160 is an example and therefore is not limited to this specific arrangement. Generally, the support member 160 includes a plurality of leg members 162 and one or more jig surface members 164. The jig support member 160 shown in FIG. 9A includes four leg members 162 and one jig surface member 164. The leg members 162 are securely connectable to, and disconnectable from, lower surface 165 of the jig surface member 164. Specifically, the secure connection of the leg members 162 to the surface member 164 may be achieved in any number of ways. For example, one end of each leg member 162 may be male threaded and the surface member 164 may contain on its lower surface 165 one female threaded port for each leg member 162, with each leg member 162 being capable of being held in the ports by engaging the male threading of the leg member 162 with the female threading of the port. As another example, one end of each of the leg members 162 may be insertable into any one of a plurality of ports on the lower surface 165 of the surface member 164. Further, the reversibly connectable leg members 162, when connected to the support member 160, optionally may be adjustable. It may be useful to adjust one or more of the leg members 162, for example, to allow all leg members 162 to contact a ground surface 200 which is uneven, such as one covered by gravel or crushed rock.

Further, the jig surface member 164 of the optional portable jig support member 160 may be adjustable. For example, whereas the surface member 164 of FIG. 9A is shown as being substantially parallel to ground surface 200, upon which the support member 160 rests, the support member 160 may be arranged to allow the surface member 164 to be held in a position that is not substantially parallel to ground surface 200. An example of one such position is shown in FIG. 9B. In that figure, surface member 164 has a first end 166 and a second end 167. Second end 167 is further removed from ground surface 200 than is first end 166. In this arrangement, therefore, the surface member 164 is inclined with respect to ground surface 200. The inclined position of FIG. 9B specifically is shown as being achieved by connecting the surface member 164 to leg members 162/162′ of unequal length. More specifically, the two leg members 162′ connected at second end 167 of the surface member 164 are longer than are the two leg members 162 at first end 166. Those skilled in the art would recognize that other arrangements of holding the surface member 164 in a position that is not substantially parallel to ground surface 200 are possible.

Specifically, some users of the jig 10/11 may wish to arrange the surface member 164 in an inclined position, such as that shown in FIG. 9B, for the purpose of making the cutting process easier to perform and/or making easier loading of the materials 50 upon, or removal of the materials 50 from, the jig 10/11. As shown in FIG. 9A, when the jig 10/11 is held substantially parallel to ground surface 200, a user standing at position 170 of the ground surface and holding his/her hands at approximately position 171 above the ground surface 200 would be required to pass the cutting device from position 172 of the jig 10/11 to position 173 of the jig 10/11 to make a complete cut. To reach position 173, however, the user would have to stretch his/her arms a substantial distance from his/her body. For many users, this would be awkward and, therefore, dangerous. As shown in FIG. 9B, the distance that the user would be required to stretch his/her arms to make a complete cut, that is to reach position 173 of the jig 10/11, could be reduced merely by bringing position 173 closer to the user by inclining the jig 10/11.

Whether the jig 10/11 is being supported by the support member 160 in an inclined position or a position substantially parallel to ground surface 200, the jig 10/11 may be securely and reversibly connected to the support member 160. For example, the jig 10/11 may include a nailing flange which runs partially or entirely around its perimeter for achieving this secure and reversible connection. In this arrangement, the nailing flange could be nailed, clamped, or screwed, for example, to the surface member 164 of the support member 160. Those skilled in the art would recognize that other arrangements of reversibly securing the jig 10/11 to the support member 160 are possible.

While the present invention has been described with particular reference to certain embodiments of the jig, it is to be understood that it includes all reasonable equivalents thereof as defined by the following appended claims.

What is claimed is:

1. A jig for cutting building materials, comprising:
a. a platform;
b. two or more rails, wherein the two or more rails are removably and securably connectable to the platform;
c. a deck arranged to allow the two or more rails to pass entirely therethrough such that the deck may be slid along the two or more rails to a selectable position; and
d. a deck fence, wherein the deck fence is removably joinable to the deck.

2. The jig of claim 1 wherein the platform includes a base member and a side wall connected to the base member.

3. The jig of claim 1 wherein the deck fence includes one or more joining members for joining the deck fence to the adjustable deck.

4. The jig of claim 3 wherein the adjustable deck includes one or more receiving ports and each of the one or more joining members is a nail, and wherein the nail is removably insertable into the receiving ports.

5. The jig of claim 1 wherein the deck fence is connected to the adjustable deck via one or more connecting members.

6. The jig of claim 5 wherein each of the one or more connecting members includes a spring-hinge.

7. The jig of claim 1 further including a platform fence, wherein the platform fence is removably joinable to the fixed platform.

8. The jig of claim 7 wherein the platform fence includes one or more joining members for joining the platform fence to the platform.

9. The jig of claim 8 wherein the platform includes one or more receiving ports and each of the one or more joining members is a nail, and wherein the nail is insertable into the receiving ports.

10. The jig of claim 1 wherein the platform fence is connected to the fixed platform via one or more connecting members.

11. The jig of claim 10 wherein each of the one or more connecting members for the platform fence includes a spring-hinge.

12. The jig of claim 1 wherein each of the two or more rails has at least one threaded end, and the fixed platform includes at least two threaded ports, wherein each of the at least one threaded end of the two or more rails is removably insertable into each of the at least two threaded ports.

13. The jig of claim 1 wherein the platform has one or more adjustable holding members reversibly fixable to the platform and the deck fence has one or more adjustable deck fence supports reversibly fixable to the deck fence.

14. The jig of claim 1 further comprising a support member having a surface member for supporting the jig thereupon.

15. The jig of claim 14 wherein the support member includes a plurality of leg members, wherein the plurality of leg members are reversibly connectable to the surface member.

16. The jig of claim 14 wherein at least one of the plurality of leg members is adjustable.

17. The jig of claim 14 wherein the support member is arranged to position the jig substantially parallel to an underlying surface.

18. The jig of claim 14 wherein the support member is arranged to position the jig non-parallel to an underlying surface.

19. The jig of claim 14 wherein the jig is reversibly connectable to the support member.

20. The jig of claim 14 wherein the jig includes a nailing flange for reversibly connecting the jig to the support member.
